(19) United States
(12) Patent Application Publication
(10) Pub. No.: US 2011/0130080 A1
(43) Pub. Date: Jun. 2, 2011

(54) FLEXIBLE, FLAT SUBSTRATE WITH AN ABRASIVE SURFACE

(75) Inventors: Daniel Käsmayr, Ludwigshafen (DE); Maxim Peretolchin, Mannheim (DE); Matthias Pfeiffer, Bohl-Iggelheim (DE); Stephan Weinkötz, Neustadt (DE)

(73) Assignee: BASF SE, Ludwigshafen (DE)

(21) Appl. No.: 13/055,264

(22) PCT Filed: Jul. 17, 2009
(86) PCT No.: PCT/EP2009/059224

§ 371 Date: Jan. 21, 2011

(30) Foreign Application Priority Data
Jul. 24, 2008 (EP) 08161065.1
Jul. 16, 2009 (EP) 09165664.5

(51) Int. Cl. B24D 11/00; B24D 3/28; B32B 27/10; B32B 29/04

(52) U.S. Cl. 451/526; 51/298; 428/147; 428/144

(57) ABSTRACT

Flexible, sheet-like substrates having an abrasive surface, which are obtainable by applying an aqueous solution or dispersion of at least one precondensate of a heat-curable resin to the top and/or bottom of a flexible, sheet-like substrate in an amount in the range from 0.1 to 90% by weight, based on the uncoated, dry substrate, crosslinking the precondensate and drying the treated substrate, wherein the aqueous solution or dispersion of at least one precondensate of a heat-curable resin comprises (i) a polymeric thickener selected from the group consisting of biopolymers, associative thickeners and wholly synthetic thickeners in an amount ranging from 0.01% by weight to 10% by weight and optionally (ii) a curative that catalyzes further condensation of the heat-curable resin at from about 60° C.

The invention relates to flexible, sheet-like substrates having an abrasive surface and their use as wiping cloths for cleaning surfaces in the household and in industry.

WO 01/94436 discloses a process for the production of resilient foams based on a melamine/formaldehyde condensate. In this process, an aqueous solution or dispersion which comprises a melamine/formaldehyde precondensate, an emulsifier, a blowing agent, a curative and, if appropriate, customary additives is foamed by heating to 120 to 300° C. and the precondensate is crosslinked. The molar ratio of melamine to formaldehyde is greater than 1:2. It is, for example, from 1:1.0 to 1:1.9. The open-cell, flexible foams thus obtainable are used mainly for heat and sound insulation of buildings and parts of buildings, for heat and sound insulation of the interiors of vehicles and aircraft and for low-temperature insulation, for example in cold stores. The foams are also used as insulating and shock-absorbing packaging material and, owing to the great hardness of crosslinked melamine resins, for mildly abrasive cleaning, and polishing sponges.

U.S. Pat. No. 6,713,156 B describes sheet-like substrates whose surface displays an abrasive effect when rubbed on other articles. Such abrasive substrates are obtained, for example, by spraying, foaming or printing polymers onto a sheet-like underlay, such as nonwovens or paper, by applying the polymers nonuniformly thereon and curing them. The curing of the polymers must take place rapidly because a nonuniform application of the polymer is responsible for the abrasive effect of the substrate. The polymer compositions used have a minimum filming temperature (MFT) of more than −10° C. and comprise at least one polymer having a Tg of at least 0° C., in general from 20 to 105° C. The polymer composition may comprise up to 20% by weight of additives, e.g. plasticizers, crosslinking agents, starch, polyvinyl alcohol, compositions heat-curable with formaldehyde, such as melamine, urea and phenol. The amount applied is in general more than 20% by weight, preferably from 30 to 50% by weight, based on nonwovens and other porous substrates. The substrates coated nonuniformly with polymers are used, for example, as scouring cloths and as wiping cloths in the household and industry, as cosmetic wipes and as swabs for wound treatment.

US 2005/0202232 discloses products which consist of at least one sheet-like melamine foam layer and at least one reinforcing layer. Basotect® from BASF SE is mentioned as the melamine foam. Basotect® is an open-cell foam based on a melamine/formaldehyde condensate. The sheet-like melamine foam layer and the likewise sheet-like reinforcing layer comprising cellulose fibers or natural or synthetic textile fibers are bonded to one another, for example, with the aid of a hotmelt adhesive. However, depending on the type of reinforcing layer, they can also be combined directly with one another, for example by the action of heat and, if appropriate, pressure. The products thus obtainable, which have a melamine foam layer on at least one side of the sheet, are used as articles for the cleaning and care of surfaces in the household and in industry, owing to the great hardness of the melamine foam layer. These are preferably disposable articles which are disposed of after use. In general, they are cloths which have a thickness of less than 5 mm, preferably from 0.85 to 2 mm.

Glues and impregnating resins which in each case are sold as aqueous binders or powders based on condensates of urea, melamine and formaldehyde, as Kauramin® and Kaurit® from BASF SE, 67056 Ludwigshafen, are used in the furniture and construction industry for the production of board-like board-base materials, such as particle boards, plywood boards and formwork boards, cf. Technische Information Kaurit®. Papers impregnated with impregnating resins have a hard surface. Such products are present, for example, in surfaces of laminate floors or in the decoration of articles of furniture, cf. Technische Information Kauramin®.

In order to increase the wet strength of paper, for example, melamine/formaldehyde resins are added to the paper stock prior to sheet formation in the production of paper, e.g. Urecoll® K, BASF SE, 67056 Ludwigshafen. The amounts of resin present in the paper stock are, for example, about 0.5 to 1% by weight, based on dry paper stock.

Known wiping cloths, such as kitchen roll or tissue, which are intended to be disposed of after use, do not have sufficient stability, particularly in the moist state, to ensure an adequate wiping effect.

WO application 2008/000665 A2 discloses a process for the finishing of paper and paper products with at least one finishing composition, at least one finishing composition being applied in the form of a pattern to the top and/or bottom of paper or paper products. In this process, smaller amounts of finishing compositions are required in comparison with known finishing processes in order to produce papers having comparable properties. Suitable finishing compositions are, inter alia, also melamine/formaldehyde resins and urea/formaldehyde resins. Viscosity-improving additives, also called thickeners, are not mentioned.

It is the object of the invention to provide substrates having an abrasive surface for cleaning surfaces in the household and in industry.

The object is achieved, according to the invention, by flexible, sheet-like substrates having an abrasive surface, which are obtainable by applying an aqueous solution or dispersion of at least one precondensate of a heat-curable resin to the top and/or bottom of a flexible, sheet-like substrate in an amount of from 0.1 to 90% by weight, based on the uncoated, dry substrate, crosslinking the precondensate and drying the treated substrate by applying an aqueous solution or dispersion of at least one precondensate of a heat-curable resin to the top and/or bottom of a flexible, sheet-like substrate in an amount in the range from 0.1 to 90% by weight, based on the uncoated, dry substrate, crosslinking the precondensate and drying the treated substrate, wherein the aqueous solution or dispersion of at least one precondensate of a heat-curable resin comprises (i) a polymeric thickener selected from the group consisting of biopolymers, associative thickeners and wholly synthetic thickeners in an amount ranging from 0.01% by weight to 10% by weight and optionally (ii) a curative that catalyzes further condensation of the heat-curable resin at from about 60° C.

The object is likewise achieved, according to the invention, by a process for producing flexible, sheet-like substrates having an abrasive surface, which comprises applying an aqueous solution or dispersion of at least one precondensate of a heat-curable resin to the top and/or bottom of a flexible, sheet-like substrate in an amount in the range from 0.1 to 90% by weight, based on the uncoated, dry substrate, then crosslinking the precondensate and drying the treated substrate, wherein the aqueous solution or dispersion of at least one precondensate of a heat-curable resin comprises (i) a polymeric thickener selected from the group consisting of biopolymers, associative thickeners and wholly synthetic thickeners in an amount ranging from 0.01% by weight to 10% by weight and optionally (ii) a curative that catalyzes further condensation of the heat-curable resin at from about 60° C.

Abrasive surface is to be understood as meaning that, on moving this surface over another surface, a rubbing or scouring effect is exerted on the other surface. While, for example, tissue papers have virtually no scouring effect during use, the substrates according to the invention, on wiping surfaces comprising glass, metal or plastic, display a scouring effect which is desired for the cleaning of these surfaces. The scouring effect here is, however, far less than that of emery paper, so that the substrates according to the invention are suitable for all those applications in which only a slight scouring effect is desired for removing dirt, so that the surface of the materials wiped with the substrates according to the invention suffers virtually no damage. The products according to the invention are preferably used as disposable articles but may also be used several times—depending on the respective application.

Examples of sheet-like substrates are paper, paperboard, cardboard, wovens (including so-called tissues), knits and fibrous nonwoven webs (including so-called nonwovens).

Paper, paperboard and cardboard can be produced from cellulose fibers of all kinds, both from natural cellulose fibers and from recovered fibers, in particular fibers from waste paper, which are frequently used as a mixture with virgin fibers. The fibers are suspended in water to give a pulp, which is drained on a wire with sheet formation. Suitable fibers for the production of the pulps are all qualities customary for this purpose in the paper industry, e.g. mechanical pulp, bleached and unbleached chemical pulp and paper stocks from all annual plants. Mechanical pulp includes, for example, groundwood, thermomechanical pulp (TMP), chemothermomechanical pulp (CTMP), pressure groundwood, semichemical pulp, high-yield pulp and refiner mechanical pulp (RMP). For example, sulfate, sulfite and soda pulps are suitable as chemical pulp. Unbleached chemical pulp, which is also referred to as unbleached craft pulp, is preferably used. Suitable annual plants for the production of paper stocks are, for example, rice, wheat, sugarcane and kenaf. The basis weight of the paper products which constitute the sheet-like substrate for the products according to the invention is, for example, from 7.5 to 500 g/m², preferably from 10 to 150 g/m², in particular from 10 to 100 g/m². Particularly preferred sheet-like substrates are tissue papers and papers which have a structured surface, for example the kitchen roll customary in the household. Such paper products have, for example, a basis weight of from 10 to 60 g/m². The sheet-like substrates used may consist of one layer or may be composed of a plurality of layers by, for example, placing the still moist layers one on top of the other immediately after production and pressing them, or adhesively bonding the already dry layers to one another with the aid of appropriate adhesives.

Wovens (including so-called tissues), knits and fibrous nonwoven webs (including so-called nowovens), which are likewise suitable as sheet-like substrates, usually consist of textile fibers or mixtures of textile fibers. Examples of these are fibers of cotton, cellulose, hemp, wool, polyamide, such as nylon, Perlon® or polycaprolactam, polyester and polyacrylonitrile. Examples of tissues and nonwovens are cleaning cloths of any kind, for example household cleaning cloths.

The thickness of the sheet-like substrates is, for example, from 0.01 to 100 mm, preferably from 0.05 to 10 mm. It is in general in the range from 0.05 to 3 mm. The sheet-like substrates are present, for example, in the form of a web or of a sheet. Such materials are flexible. They retain their flexibility even after the application and curing of a heat-curable resin, which in fact is to be applied at most in an amount such that the flexibility of the untreated substrate is just retained. Although the flexibility of the untreated substrate decreases owing to the application of the heat-curable resin, the amount of resin is such that rigid, inflexible structures, as are usual, for example, in furniture veneers, do not form. The paper coated according to the invention may on no account be brittle and should not break like glass on bending and on folding. Cardboard coated according to the invention is also bendable without destruction but has a substantially improved wiping effect compared with uncoated cardboard.

For the production of the flexible, sheet-like substrates having an abrasive surface, sheet-like substrates, such as fibrous nonwoven webs (including so-called nonwovens), wovens (including so-called tissues), knits, paper, paperboard and cardboard are first treated with an aqueous solution or dispersion of a precondensate of at least one heat-curable resin.

The precondensates of the heat-curable resins are selected from the group consisting of the melamine/formaldehyde precondensates, urea/formaldehyde precondensates, urea/glyoxal precondensates and phenol/formaldehyde precondensates.

It is preferable to use a precondensate of melamine and formaldehyde in which the molar ratio of melamine to formaldehyde is greater than 1:2. A precondensate of melamine and formaldehyde in which the molar ratio of melamine to formaldehyde is from 1:1.0 to 1:1.9 is preferably used as the heat-curable resin. Melamine/formaldehyde condensates may comprise, incorporated in the form of condensed units, up to 50% by weight, preferably up to 20% by weight, of other precursors of thermosetting plastics in addition to melamine and up to 50% by weight, in general up to 20% by weight, of other aldehydes in addition to formaldehyde. Suitable precursors of thermosetting plastics are, for example, alkyl- and aryl-substituted melamine, urea, urethanes, carboxamides, dicyandiamide, guanidine, sulfurylamide, sulfonamides, aliphatic amines, glycols, phenol and phenol derivatives. Acetaldehyde, propionaldehyde, isobutyraldehyde, n-butyraldehyde, trimethylolacetaldehyde, acrolein, benzaldehyde, furfurol, glyoxal, glutaraldehyde, phthalaldehyde and terephthalaldehyde may be used as aldehydes, for example for partly replacing the formaldehyde in the condensates.

The precondensates can, if appropriate, be etherified with at least one alcohol. Examples of this are monohydric C₁- to C₁₈-alcohols, such as methanol, ethanol, isopropanol, n-propanol, n-butanol, sec-butanol, isobutanol, n-pentanol, cyclopentanol, n-hexanol, cyclohexanol, n-octanol, decanol, palmityl alcohol and stearyl alcohol, polyhydric alcohols, such as glycol, diethylene glycol, glycerol, 1,4-butanediol, 1,6-hexanediol, polyethylene glycols having 3 to 20 ethylene oxide units, glycols and polyalkylene glycols endcapped at one end, 1,2-propylene glycol, 1,3-propylene glycol, polypropylene glycols, pentaerythritol and trimethylolpropane.

The preparation of heat-curable resins is part of the prior art, cf. Ullmann's Encyclopedia of Industrial Chemistry, Sixth Completely Revised Edition, Wiley-VCH Verlag GmbH Co. KgaA, Weinheim, “Amino Resins”, Vol. 2, pages 537-565 (2003).

The starting material used is an aqueous solution or dispersion of a precondensate, preferably of melamine and formaldehyde. The solids concentration is, for example, from 5 to 95% by weight, preferably in the range from 10 to 70% by weight.

The solution or dispersion of the precondensate may comprise a curative but can also be used without curative.

Curatives are selected from substances that act as curatives, i.e., catalyze further condensation of the heat-curable resins, at from about 60° C.; such curatives according to the present invention are hereinafter also referred to as “slow” curatives according to the present invention.

Whether a substance is a “slow” curative according to the present invention can generally be determined by means of a few comparative tests involving customary acid type curatives, for example formic acid, in the customary amounts. The viscosity elevation of the precondensate solution or dispersion admixed with “slow” curatives according to the present invention proceeds much slower than a comparable precondensate solution to which formic acid, for example, was added as curative under comparable conditions.

Particularly suitable “slow” curatives according to the invention comprise as curative-active components salts of acids with ammonia or amines or adducts of Lewis acids (sulfur dioxide for example) with ammonia or amines. Examples of “slow” curatives according to the present invention are ammonium nitrate, or the materials bearing the product designations “Härter 423”, “Härter 527”, “Härter 528”, “Härter 529” from BASF SE.

In particular cases, the “slow” curatives according to the present invention which are recited for the condensation can also be applied separately to the sheet-like substrate.

The amounts used of “slow” curatives according to the present invention are generally in the range from 0.01 to 70% by weight and preferably in the range from 0.05 to 60% by weight, based on the resin.

The aqueous solution or dispersion of a precondensate of a heat-curable resin can, if appropriate, also comprise a surfactant. For example, nonionic, anionic and cationic surfactants and mixtures of at least one nonionic and at least one anionic surfactant, mixtures of at least one nonionic and at least one cationic surfactant, mixtures of a plurality of nonionic or of a plurality of cationic or of a plurality of anionic surfactants are suitable.

All surface-active agents are suitable, for example, as surfactants. Examples of suitable nonionic surface-active substances are ethoxylated mono-, di- and trialkylphenols (degree of ethoxylation: from 3 to 50, alkyl radical: C₃-C₁₂) and ethoxylated fatty alcohols (degree of ethoxylation: from 3 to 80: alkyl radical: C₈-C₃₆). Examples of these are the Lutensol® brands of BASF SE or the Triton® brands of Union Carbide. Ethoxylated linear fatty alcohols of the general formula

n-CₓH₂ₓ₊₁—O(CH₂CH₂O)_{y}—H,

where x is an integer in the range from 10 to 24, preferably in the range from 12 to 20, are particularly preferred. The variable y is preferably an integer in the range from 5 to 50, particularly preferably from 8 to 40. Ethoxylated linear fatty alcohols are usually present as a mixture of different ethoxylated fatty alcohols having different degrees of ethoxylation. In the context of the present invention, the variable y is the average value (number average). Suitable nonionic surface-active substances are furthermore copolymers, in particular block copolymers, of ethylene oxide and at least one C₃-C₁₀-alkylene oxide, e.g. three-block copolymers of the formula

RO(CH₂CH₂O)_{y1}—(BO)_{y2}-(A-O)ₘ—(B′O)_{y3}—(CH₂CH₂O)_{y4}R′,

where m is 0 or 1, A is a radical derived from an aliphatic, cycloaliphatic or aromatic diol, e.g. ethane-1,2-diyl, propane-1,3-diyl, butane-1,4-diyl, cyclohexane-1,4-diyl, cyclohexane-1,2-diyl or bis(cyclohexyl)methane-4,4′-diyl, B and B′, independently of one another, are propane-1,2-diyl, butane-1,2-diyl or phenylethanyl, independently of one another, are a number from 2 to 100 and y2 and y3, independently of one another, are a number from 2 to 100, the sum y1+y2+y3+y4 preferably being in the range from 20 to 400, which corresponds to a number average molecular weight in the range from 1000 to 20000. A is preferably ethane-1,2-diyl, propane-1,3-diyl or butane-1,4-diyl. B is preferably propane-1,2-diyl.

Fluorine-substituted polyalkylene glycols, which are commercially available, for example, under the trade name Zonyl® (DuPont), are also suitable as surface-active substances.

In addition to the nonionic surfactants, other suitable surface-active substances are anionic and cationic surfactants. They can be used alone or as a mixture. A precondition for this, however, is that they are compatible with one another, i.e. they do not give precipitates with one another. This precondition applies, for example, to mixtures of one class of compounds in each case and to mixtures of nonionic and anionic surfactants and mixtures of nonionic and cationic surfactants. Examples of suitable anionic surface-active agents are sodium laurylsulfate, sodium dodecylsulfate, sodium hexadecylsulfate and sodium dioctylsulfosuccinate.

Examples of cationic surfactants are quaternary alkylammonium salts, alkylbenzyl-ammonium salts, such as dimethyl-C₁₂- to C₁₈-alkylbenzylammonium chlorides, primary, secondary and tertiary fatty amine salts, quaternary amidoamine compounds, alkylpyridinium salts, alkylimidazolinium salts and alkyloxazolinium salts.

Anionic surfactants, such as, for example, (optionally alkoxylated) alcohols which are esterified with sulfuric acid and are generally used in a form neutralized with alkali are particularly preferred. Further customary emulsifiers are, for example, sodium alkanesulfonates, sodium alkylsulfates, such as, for example, sodium laurylsulfate, sodium dodecylbenzenesulfonate, and sulfosuccinates. Furthermore, esters of phosphoric acid or of phosphorous acid and aliphatic or aromatic carboxylic acids can also be used as anionic emulsifiers. Customary emulsifiers are described in detail in the literature, cf. for example M. Ash, I. Ash, Handbook of Industrial Surfactants, Third Edition, Synapse Information Resources Inc.

The aqueous solution or dispersion of at least one precondensate may comprise the surfactants in an amount of up to 10% by weight. If it comprises a surfactant, the amounts of surfactant which are preferably present in the solution or dispersion are from 0.01 to 5% by weight.

The aqueous solution or dispersion of the precondensate can, if appropriate, comprise further customary additives, e.g. particulate, inorganic compounds, such as silica, alumina, silicon carbide, titanium dioxide, zinc oxide, calcium carbonate, marble and corundum. The mean particle diameter of the inorganic compounds is, for example, from 1 nm to 500 μm.

The amount of these additives is, for example, from 0 to 100, preferably from 0 to 25, % by weight, based on the solution or dispersion.

The flexible, sheet-like substrates according to the invention are preferably free of materials which display a scouring effect when rubbed on another surface, such as, for example, silicon carbide or alumina.

The flexible, sheet-like substrates of the present invention, for example paper, paperboard, cardboard, wovens (including so-called tissues), knits and fibrous nonwoven webs (including so-called nonwovens), preferably wovens (including so-called tissues), knits and fibrous nonwoven webs (including so-called nonwovens), may comprise active and benefit agents, preferably in an amount ranging from 0.01% by weight to 10% by weight and more preferably from 0.01% by weight to 1% by weight, in addition to or instead of the abovementioned customary added substances.

Such active and benefit agents are preferably scents, dyes or pigments, waxes, surfactants, surface-active materials, amphiphilic polymers, care agents for surfaces, shine generators, antibacterial finish, biocides, silver ions, nanoparticles, silicones.

The active and benefit agents, preferably volatile active and benefit agents such as scents or else water-insoluble active and benefit agents, such as waxes or silicones, may be present in encapsulated form, preferably in microcapsules.

The active and benefit agents can be applied to or incorporated in the flexible, sheet-like substrates of the present invention in any desired manner. They are preferably applied to the sheet-like substrates in the same operation as the resin. It is particularly preferable to use them as part of the resin solution or dispersion.

In a particularly suitable process, the active and benefit agents, preferably unencapsulated or (micro)encapsulated scents, are added to the ready-produced aqueous solution or dispersion of the precondensate before this solution or dispersion is applied to the sheet-like substrate, preferably paper, paperboard, cardboard, wovens (including so-called tissues), knits and fibrous nonwoven webs (including so-called nonwovens).

In a further particularly suitable process, the active and benefit agents, preferably unencapsulated or (micro)encapsulated scents, are added in the course of the preparation of the aqueous solution or dispersion of the precondensate and this solution or dispersion is then applied to the sheet-like substrate, preferably paper, paperboard, cardboard, wovens (including so-called tissues), knits and fibrous nonwoven webs (including so-called nonwovens).

In a further particularly suitable process, the active and benefit agents, preferably unencapsulated or (micro)encapsulated scents, are added in the course of the preparation of the precondensate. This mixture is then converted into an aqueous solution or dispersion only shortly before application to the sheet-like substrate and then applied to the sheet-like substrate, preferably paper, paperboard, cardboard, wovens (including so-called tissues), knits and fibrous nonwoven webs (including so-called nonwovens).

The effect and benefit agents mentioned, preferably the (micro)encapsulated active and benefit agents and more preferably the (micro)encapsulated volatile active and benefit agents such as scents and are water-insoluble active and benefit agents, such as waxes or silicones, are typically released, partly or wholly, on the flexible, sheet-like substrates, being subjected to a mechanical stress, such as rubbing, wiping or other cleaning.

Achieving good and very uniform distribution of the resin, preferably on the surface of the substrate and not in its deeper layers, in the course of the application of the resin requires a particular rheological behavior or a particular viscosity on the part of the aqueous solution or dispersion of the precondensate. The aqueous solution or dispersion of the precondensate must be sufficiently liquid to easily spread out over the substrate, but not so liquid that, in the course of its being spread out, it penetrates, or is sucked, rapidly into the deeper layers of the substrate.

It is further important to achieve good and very uniform distribution of the aqueous solution or dispersion of the precondensate on the corresponding resin application devices, for example press rolls, to achieve a uniform transfer of the aqueous solution or dispersion of the precondensate to the substrate, for example paper, paper board, cardboard, wovens (including so-called tissues), knits and fibrous nonwoven web (including so-called nonwovens).

It is further important to achieve a suitable viscosity for the aqueous solution or dispersion of the precondensate in order that on application of the aqueous solution or dispersion of the precondensate by spraying the droplet size of the precondensate is as small as possible, the droplets do not clog the spray nozzle and become uniformly distributed on the substrate.

Therefore, the aqueous solution or dispersion of the precondensate comprises a polymeric thickener in the range from 0.01% to 10% by weight and preferably in the range from 0.01% to 5% by weight, based on the aqueous solution or dispersion of the precondensate.

Such polymeric thickeners are selected from the group consisting of:

a) biopolymers, such as a1 polysaccharides, for example starch, guar gum, carob gum, agar, pectins, gum Arabic, xanthan; a2) proteins, for example gelatin, casein; b) associative thickeners, such as b1) modified celluloses, for example methylcellulose (MC), hydroxyethylcellulose (HEC), hydroxypropylmethylcellulose (HPMC), hydroxypropylcellulose (HPC) and ethylhydroxyethylcellulose (EHEC); b2) modified starches, for example hydroxyethyl starch and hydroxypropyl starch; c) wholly synthetic thickeners, for example polyvinyl alcohols, polyacrylamides, polyvinylpyrrolidones and polyethylene glycols.

It will be appreciated that any mixtures of the aforementioned thickeners a) and/or b) and/or c) are also comprised.

In order to produce the products according to the invention, the solution or dispersion of the precondensate (also referred to below as “preparation solution”) can be applied to the substrate either over the whole surface or in the form of a pattern. The preparation solution may also be foamed prior to the application to the sheet-like substrate, for example by stirring in air or other gases. Sheet-like substrates which are coated with a foam whose cells, in contrast to a known foam comprising a heat-curable resin based on melamine and formaldehyde, such as Basotect®, have a mean diameter in the nanometer range, e.g. from 1 to 1000 nm, are then obtained after curing and drying.

The viscosity of the preparation solution, i.e., of the aqueous solution or dispersion of the precondensate with or without high curative, is typically set by adding the thickeners of the present invention and thereafter applied to the substrate and only then cured.

Conventionally, the viscosity of aminoplast-containing preparation solutions is altered by addition of a “fast” curative based on an organic or inorganic acid. This effectuates even at room temperature and more particularly at elevated temperature for about 40 to 60° C. a comparatively rapid further condensation of the resin in the preparation solution, which generally leads to a viscosity elevation of the preparation solution. However, this operation is difficult to police and leads to a very short pot life on the part of the corresponding further-condensed preparation solution. This is disadvantageous in a continuous application facility in particular.

The present invention makes it possible to set the viscosity desired for the preparation solution without uncontrolled further condensation.

The preparation solution according to the invention is preferably applied in the unfoamed state to the underlay suitable in each case. It can be applied to the sheet-like substrate, for example, by spraying, knifecoating, roll-coating, printing or with the aid of other suitable industrial apparatuses which are known to a person skilled in the art, such as, for example, a size press, a film press, an airbrush or a curtain coating unit. Noncontact methods or methods employing as little pressure as possible to the sheet-like substrate are preferably used in order to reduce the absorption of the resin into the substrate.

The application can be carried out on one side or both sides, either simultaneously or in succession. The amount of curable resin which is applied with the aid of the preparation solution to the sheet-like substrate is, for example, from 0.1 to 90% by weight, preferably from 0.5 to 50% by weight, in particular from 0.5 to 30% by weight, based on the basis weight of the uncoated, dry sheet-like substrate.

It is therefore substantially below the amount which is used for the production of decorative sheets by impregnating sheet-like substrates with melamine/formaldehyde resins. The amount of precondensate applied in each case to the substrate has a decisive influence on the flexibility, softness and handle of the products according to the invention.

In addition, the distribution of the preparation solution or of the cured resin over the substrate has a considerable influence on the flexibility of the products according to the invention. The preparation solution can be applied, for example, nonuniformly to the underlay, said preparation solution, for example, covering the whole area of the underlay but not being uniformly distributed thereon. A further variation comprises printing the preparation solution in the form of a pattern on the sheet-like substrate. For example, particularly flexible products are thus obtained if the preparation solution is printed in the form of parallel strips or dots on the underlay.

After the application of the preparation solution to the sheet-like underlay, crosslinking of the heat-curable resin and drying of the sheet-like substrates provided with a coat of a precondensate of a heat-curable resin are effected, it being possible for crosslinking and drying to take place simultaneously or in succession. In an advantageous embodiment, the heat-curable resin is crosslinked in a moist atmosphere and the product is then dried. The thermal curing of the resins and the drying of the products can take place, for example, in the temperature range from 20 to 250° C., preferably from 20 to 200° C., particularly preferably from 20 to 150° C.

The drying step can also be carried out, for example, in gas dryers or in IR dryers. The higher the temperature used in each case, the shorter the residence time of the material to be dried in the drying apparatus. If desired, the product according to the invention may also be heated at temperatures up to 300° C. after the drying. Temperatures above 300° C. can also be used for curing the resin, but the required residence times are then very short.

The process of the present invention leads to the flexible, sheet-like substrates in which, as far as is currently known, the resin is not homogeneously distributed in the substrate, but remains essentially on the surface of the substrate, namely as an added-on layer.

Flexible, sheet-like substrates which are used as wiping cloths for cleaning surfaces in the household and in industry are obtained. They are suitable in particular as abrasive wiping cloths for cleaning the surfaces of articles comprising metal, glass, porcelain, plastic and wood. The products according to the invention are suitable in particular as disposable articles but, if appropriate, can be used several times. They can be used several times especially in the case of those products according to the invention which comprise a woven fabric or nonwoven as an underlay.

The stated percentages in the examples are percentages by weight, unless evident otherwise from the context.

### EXAMPLES

### Distinguishing Types of Curative (“Fast” and “Slow” Curatives)

A solution of 100 g of an impregnating resin (melamine-formaldehyde resin) from BASF SE (see table) was admixed with the stated amount of curative and introduced into jam glasses with lids. The mixtures were shaken by hand at room temperature and the viscosity of the samples was assessed in the process. The table below records the times between which the solution was workable.

| | | Amount | Start | End | Workability window |
|---|---|---|---|---|---|
| Condensate | Curative | % w/w | min | min | min |
| KMT 792 | formic acid | 5 | 42 | 97 | 55 |
| KMT 792 | formic acid | 20 | 6.5 | 9.5 | 3 |
| KMT 783 | formic acid | 5 | 24.5 | 57 | 32.5 |
| KMT 783 | formic acid | 20 | 10 | 18.5 | 8.5 |
| KMT 753 | formic acid | 5 | 33.5 | 59.5 | 26 |
| KMT 753 | formic acid | 20 | 8 | 11 | 3 |
| KMT 753 | Härter 528 | 1 | 60+ | | >1000 |
| KMT 753 | Härter 528 | 5 | 60+ | | >1000 |
| KMT 753 | Härter 528 | 20 | 60+ | | >1000 |

Härter 527, Härter 528 and Härter 529 from BASF SE are based on organic amines.

### Producing Coated Papers

### Preparation Solution 1 (Comparative)

A 20% strength aqueous solution was prepared from a pulverulent precondensate of melamine and formaldehyde (Kauramin® KMT 773 (powder, BASF)) and water by initially taking demineralized water in a beaker, slowly introducing the powder and then treating the mixture for one hour with an Ultra-Turrax® which was set to the highest speed. The aqueous solution of the precondensate was then filtered over a fluted filter. 3.5 g of formic acid (100% strength) and 100 μl of a fluorine-substituted surface-active agent (Zonyl® FS 300, DuPont) were added to 30 g of this solution and the mixture was stored for 6 minutes at a temperature of 70° C. in a drying oven.

### Preparation Solution 2 (Inventive)

A 28% aqueous solution was prepared from a precondensate of melamine and formaldehyde (Kauramin® KMT 753 (solution, BASF SE)) and water by mixing completely ion-free water with the impregnating resin solution. To 30 g of this solution was added 0.25 g of Härter 528 (80% strength) and 100 μl of a fluorine-substituted surface-active agent (Zonyl® FS 300, DuPont) and also 0.042 g of guar gum, so that the viscosity of preparation solution 2 had a value of about 150 mPa*s.

Preparation Solution 2a (Inventive with Benefit Agent)

A 28% aqueous solution was prepared from a precondensate of melamine and formaldehyde (Kauramin® KMT 753 (solution, BASF SE)) and water by mixing completely ion-free water with the impregnating resin solution. To 30 g of this solution was added 100 microliters of a fluorine-substituted surface-active agent (Zonyl® FS 300, DuPont) and also 0.042 g of guar gum, so that the viscosity of preparation solution 2a had a value of about 128 mPa*s. 2% by weight, based on the mass of the resin used, of scent capsules were dispersed in this solution. 5 min before the solution was printed onto the paper, the resin solution was admixed with 0.48 g of formic acid (corresponds to 10% by weight based on the solids fraction of the resin).

Preparation Solution 3 (Inventive, without Curative)

A 28% aqueous solution was prepared from a precondensate of melamine and formaldehyde (Kauramin® KMT 753 (solution, BASF SE)) and water by mixing completely ion-free water with the impregnating resin solution. To 30 g of this solution was added 100 microliters of a fluorine-substituted surface-active agent (Zonyl® FS 300, DuPont) and also 0.042 g of guar gum, so that the viscosity of preparation solution 2 had a value of about 137 mPa*s.

### Example 1

### Transfer Press, Preparation Solution 2

A portion of preparation solution 2 was applied with the aid of a transfer press to one side of a 23.8 cm×25.7 cm piece of kitchen roll (TORK® (Premium) kitchen roll, SCA) having a basis weight of 53 g/m². The coated material was then placed on an aluminum plate and dried for 20 min at 120° C. in a drying cabinet. Thereafter, the paper was in a dry and crosslinked state. The amount of resin applied was 13%, based on dry kitchen roll.

### Example 2

### Printing Press, Preparation Solution 2

A portion of preparation solution 2 was applied with the aid of a printing press to one side of a 23.8 cm×25.7 cm piece of kitchen roll (TORK® (Premium) kitchen roll, SCA) having a basis weight of 53 g/m². The coated material was then placed on an aluminum plate and dried for 20 min at 120° C. in a drying cabinet. Thereafter, the paper was in a dry and crosslinked state. The amount of resin applied was 5%, based on dry kitchen roll.

### Example 3

### Printing Press, Preparation Solution 3

A portion of preparation solution 3 was applied with the aid of a printing press to one side of a 23.8 cm×25.7 cm piece of kitchen roll (TORK® (Premium) kitchen roll, SCA) having a basis weight of 53 g/m². The coated material was then placed on an aluminum plate and dried for 60 min at 120° C. in a drying cabinet. Thereafter, the paper was in a dry and crosslinked state. The amount of resin applied was 5%, based on dry kitchen roll.

### Example 4

### Comparative, Preparation Solution 1

An attempt was made to apply a portion of preparation solution 1 with the aid of a printing press to one side of a 23.8 cm×25.7 cm piece of kitchen roll (TORK® (Premium) kitchen roll, SCA) having a basis weight of 53 g/m². Application was very inhomogeneous, the viscosity of preparation solution 1 increased rapidly, and preparation solution 1 did not wet the paper uniformly. Removing the treated paper from the press roll was not possible without destroying the paper because the paper was badly stuck to the press roll.

### Example 5

### Transfer Press, Version with Benefit Agent, Preparation Solution 2a

A portion of preparation solution 2a was applied with the aid of a transfer press to one side of a 23.8 cm×25.7 cm piece of kitchen roll (TORK® (Premium) kitchen roll, SCA) having a basis weight of 53 g/m². The coated material was then placed on an aluminum plate and dried for 20 min at 120° C. in a drying cabinet. Thereafter, the paper was in a dry and crosslinked state. The amount of resin applied was 12%, based on dry kitchen roll.

### Cleaning Effect

The coated papers obtained according to the examples were tested for their suitability as wiping cloths and compared with commercially available, uncoated papers. For this purpose, the sample to be tested was fixed in each case to one side of a cylindrical punch having a diameter of 13 mm and a weight of 600 g with the aid of an adhesive. A glass panel was fastened on a mechanical shaker (Crock-Meter). Several strips were then drawn on the glass panel with a permanent marker (Permanent Marker Edding 3000). The cylindrical punch was placed on this surface, that side of the punch which was adhesively bonded to the sample to be tested resting in each case on the glass panel. That part of the panel which was to be cleaned was optionally moistened with 0.5 ml of demineralized water. The mechanical shaker operated with 20 double strokes/min with a horizontal panel deflection of 5 cm. After 30 strokes, or 5 strokes in the moist, the degree of removal of the marks from the plate was determined. To this end, the plates were photographed in a reflected light scanner and the average gray value of the Edding stripes changed by the rubbing action of the cloths was determined with the aid of Image J (NIH) software. The relative cleaning effect (0%=no effect, 100%=fully cleaned) was then determined by comparison with reference samples.

The tests carried out and results obtained are shown in the table below.

| | Relative cleaning | |
|---|---|---|
| | effect | |
| Cloth | dry | moist |
| Example 1 | 63% | 92% |
| Example 2 | 70% | 100% |
| Example 3 | 65% | 86% |
| Example 5 | 60% | 95% |
| No coating | 0% | 20% |

### Example 6

### Transfer Press, Preparation Solution 2

A portion of preparation solution 2 was applied with the aid of a transfer press to one side of a 20 cm×20 cm piece of a tissue having a basis weight of 35 g/m². The coated material was then placed on an aluminum plate and dried for 20 min at 120° C. in a drying cabinet. Thereafter, the substrate was dry and the resin layer was in a cured state. The amount of resin applied was 7.8% based on the basis weight of the uncoated material.

Samples of the material thus prepared were examined by means of confocal Raman microscopy for the distribution of melamine within the tissue.

### Sample Preparation and Method of Measurement: Confocal Raman Microscopy:

The sample was scanned in a depth scan (XZ direction). Since in the course of this scan the focal plane changed constantly as a result of the heating by the laser, the sample was embedded in epoxy resin and a section was prepared. This section was scanned laterally (XY plane) using a 100× lens (excitation 532 nm), since this corresponds to the imaging of the chemical composition across the sample thickness. The characteristic signals of the individual components were integrated and depicted as false colors versus spatial coordinates (XY). Evaluation is based on the following bands:

melamine: 975 cm-1 epoxy resin: 3075 cm-1 paper: 3130-3620 cm-1

### Results of Raman Mapping:

There is a very thin layer of melamine on the upper surface of the paper. Owing to the absorbency of the tissue paper, the coating has penetrated into the interspace to the next fiber up to 25 μm sample depth. No melamine was detectable at greater depth in the tissue.

1.-17. (canceled)

18. A flexible, sheet-like substrate having an abrasive surface, obtainable by applying an aqueous solution or dispersion of at least one precondensate of a heat-curable resin to the top and/or bottom of a flexible, sheet-like substrate in an amount in the range from 0.1 to 90% by weight, based on the uncoated, dry substrate, crosslinking the precondensate and drying the treated substrate, wherein the aqueous solution or dispersion of at least one precondensate of a heat-curable resin comprises (i) a polymeric thickener selected from the group consisting of biopolymers, associative thickeners and wholly synthetic thickeners in an amount ranging from 0.01% by weight to 10% by weight and optionally (ii) a curative that catalyzes further condensation of the heat-curable resin at from about 60° C.

19. The flexible, sheet-like substrate according to claim 18, wherein the precondensates of the heat-curable resins are selected from the group consisting of the melamine/formaldehyde precondensates, urea/formaldehyde precondensates, urea/glyoxal precondensates and phenol/formaldehyde precondensates.

20. The flexible, sheet-like substrate according to claim 18, wherein the heat-curable resin used is a precondensate of melamine and formaldehyde in which the molar ratio of melamine to formaldehyde is greater than 1:2.

21. The flexible, sheet-like substrate according to claim 20, wherein the heat-curable resin used is a precondensate in which the molar ratio of melamine to formaldehyde is from 1:1.0 to 1:1.9.

22. The flexible, sheet-like substrate according to claim 18, wherein the substrate is selected from the group consisting of fibrous nonwoven webs (including so-called nonwovens), wovens (including so-called tissues), knits, paper, paperboard and cardboard.

23. The flexible, sheet-like substrate according to claim 18, wherein the substrate is paper or a fibrous nonwoven web (including so-called nonwovens) composed of cellulose fibers, or a woven (including so-called tissues) composed of cellulose fibers.

24. The flexible, sheet-like substrate according to claim 18, wherein the solution or dispersion of the precondensate comprises at least one curative (ii).

25. The flexible, sheet-like substrate according to claim 18, wherein the solution or dispersion of the precondensate comprises at least one surfactant.

26. The flexible, sheet-like substrate according to claim 18, wherein the solution or dispersion of the precondensate comprises from 0.01 to 5% by weight of at least one polymeric thickener (i).

27. The flexible, sheet-like substrate according to claim 18, wherein the solution or dispersion of the precondensate is applied to the whole surface of the substrate.

28. The flexible, sheet-like substrate according to claim 18, wherein the aqueous solution or dispersion of the precondensate is applied in the form of a pattern to the substrate.

29. The flexible, sheet-like substrate according to claim 18, wherein the substrate treated with an aqueous solution of a precondensate is cured and dried at a temperature in the range of from 20 to 150° C.

30. The flexible, sheet-like substrate according to claim 18, wherein the amount of the heat-curable resin, based on the uncoated, dry substrate, is from 0.5 to 50% by weight.

31. The flexible, sheet-like substrate according to claim 18, comprising active and benefit agents in addition to or instead of customary added substances.

32. The flexible, sheet-like substrate according to claim 18, comprising active and benefit agents in encapsulated form in addition to or instead of customary added substances.

33. A wiping cloth for cleaning surfaces in the household and in industry which comprises the flexible, sheet-like substrate according to claim 18.

34. A process for producing the flexible, sheet-like substrate having an abrasive surface as defined in claim 18, which comprises applying an aqueous solution or dispersion of at least one precondensate of a heat-curable resin to the top and/or bottom of a flexible, sheet-like substrate in an amount in the range from 0.1 to 90% by weight, based on the uncoated, dry substrate, crosslinking the precondensate and drying the treated substrate, wherein the aqueous solution or dispersion of at least one precondensate of a heat-curable resin comprises (i) a polymeric thickener selected from the group consisting of biopolymers, associative thickeners and wholly synthetic thickeners in an amount ranging from 0.01% by weight to 10% by weight and optionally (ii) a curative that catalyzes further condensation of the heat-curable resin at not less than about 60° C.
